(19) United States
(12) Patent Application Publication
(10) Pub. No.: US 2008/0071874 A1
(43) Pub. Date: Mar. 20, 2008

(54) METHOD AND SYSTEM FOR TARGETED COMMUNICATION

(76) Inventors: Benjamin Roodman, Maryland Heights, MO (US); David Gorman, St. Louis, MO (US); Ethan Thiel, St. Louis, MO (US)

Correspondence Address: SCHWEGMAN, LUNDBERG & WOESSNER, P.A., P.O. BOX 2938, MINNEAPOLIS, MN, 55402, US

(21) Appl. No.: 11/857,963

(22) Filed: Sep. 19, 2007

Related U.S. Application Data
(60) Provisional application No. 60/826,155, filed on Sep. 19, 2006.

(51) Int. Cl. G06F 15/16

(52) U.S. Cl. 709/206

(57) ABSTRACT

A message may be received from an originating user. A target criterion may be received from the originating user. A number of a plurality of target users meeting the target criterion may be determined. The plurality of target users may be associated with a server. The meeting of the target criterion may be based on target user data associated with the server. The number of the plurality of target users associated with the target criterion may be presented to the originating user. A delivery request may be received from the originating user. The message may he sent to the plurality of target users based on the receiving of the delivery request.

### PRIORITY CLAIM

This application claims the priority benefit of U.S. Provisional Application No. 60/826,155, filed 19 Sep. 2006, which is incorporated herein by reference.

### TECHNICAL FIELD

This application relates to a communication system and more particularly to a method and system for targeted interaction.

### BACKGROUND

Users may seek information regarding events, performer groups (e.g., bands) and venues. Users may search the Internet to obtain additional information. Occasionally, users may subscribe to a mailing list associated with a performer group or venue to continue to receive information respectively regarding the performer group or venue.

### BRIEF DESCRIPTION OF DRAWINGS

Embodiments are illustrated by way of example and not limitation in the figures of the accompanying drawings, in which like references indicate similar elements and in which:

FIG. 1 is a block diagram of a communication system to deliver targeted messages in accordance with an example embodiment;

FIG. 2 is a block diagram of a communication system to deliver targeted messages in accordance with an example embodiment;

FIG. 3 is a flowchart illustrating a method in accordance with an example embodiment for processing user interaction with the messaging system;

FIG. 4 is a flowchart illustrating a method in accordance with an example embodiment for modifying user data;

FIG. 5 is a flowchart illustrating a method in accordance with an example embodiment for selecting a data structure for modification;

FIG. 6 is a flowchart illustrating a method in accordance with an example embodiment for creating and/or modifying a data structure;

FIG. 7 is a flowchart illustrating a method in accordance with an example embodiment for verifying a data structure;

FIG. 8 is a flowchart illustrating a method in accordance with an example embodiment for sending a targeted message;

FIG. 9 is a flowchart illustrating a method in accordance with an example embodiment for responding to a targeted message;

FIG. 10 is a flowchart illustrating a method in accordance with an example embodiment for processing received media;

FIG. 11 is a flowchart illustrated a method in accordance with an example embodiment for associating media with data structures;

FIG. 12 is a block diagram of a user data structure according to an example embodiment;

FIG. 13 is a block diagram of a venue data structure according to an example embodiment;

FIG. 14 is a block diagram of a performer data structure according to an example embodiment;

FIG. 15 is a block diagram of a performer group data structure according to an example embodiment;

FIG. 16 is a block diagram of a system code data structure according to an example embodiment;

FIG. 17 is a block diagram of an event data structure according to an example embodiment;

FIG. 18 is a block diagram of a media data structure according to an example embodiment;

FIG. 19 is a block diagram of a location data structure according to an example embodiment;

FIG. 20 is a block diagram of a performance data structure according to an example embodiment;

FIG. 21 is a block diagram of an extended field data structure according to an example embodiment;

FIGS. 22-28 are block diagrams of a user interface in accordance with example embodiments;

FIG. 29 is a block diagram of an example application server that may be deployed in the communication system of FIG. 1 or FIG. 2; and

FIG. 30 illustrates a diagrammatic representation of machine in the example form of a computer system within which a set of instructions for causing the machine to perform any one or more of the methodologies discussed herein may be executed.

### DETAILED DESCRIPTION

In the following detailed description of example embodiments, reference is made to the accompanying drawings, which form a part hereof, and in which is shown, by way of illustration, specific embodiments in which the example method, apparatus, and system may be practiced. It is to be understood that other embodiments may be utilized and structural changes may be made without departing from the scope of this description.

In an example embodiment, a message may be received from an originating user. A target criterion may be received from the originating user. A number of a plurality of target users meeting the target criterion may be determined. The plurality of target users may be associated with a server. The meeting of the target criterion may be based on target user data associated with the server. The number of the plurality of target users associated with the target criterion may be presented to the originating user. A delivery request may be received from the originating user. The message may be sent to the plurality of target users based on the receiving of the delivery request.

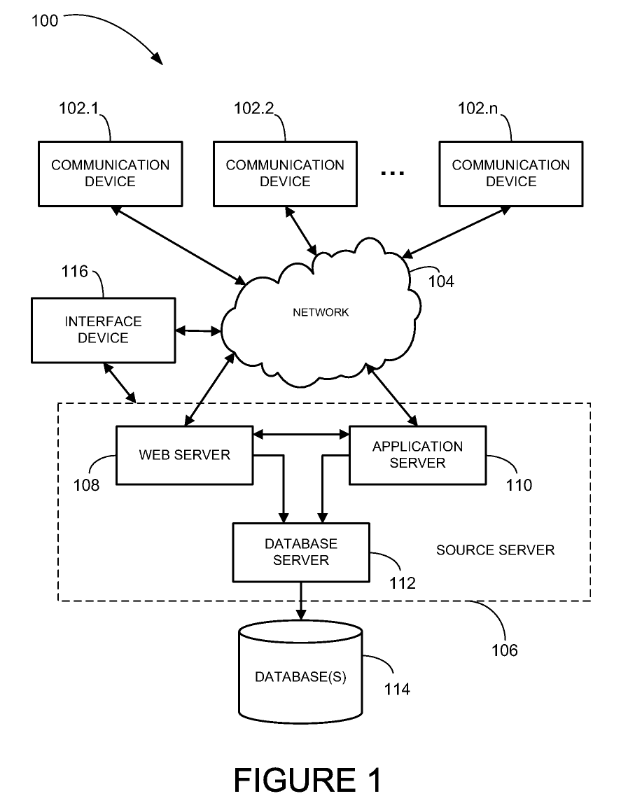

FIG. 1 illustrates a communication system 100 according to an example embodiment. The communication system may include one or more communication devices 102.1-102.n in communication with a source server 106 over a network 104. A user may use a communication device of the communication devices 102.1-102.n to interact with the source server 106. For example, a user may receive targeted messages (e.g., solicited messages matching interests of the user) from the source server 106, respond to targeted messages received from the source server 106, search for targeted information, configure user data within the source server 106, provide content from a communication device to the source server 106, and the like.

The communication devices 102.1-102.n may include devices capable of transmitting, receiving and/or reproducing data. In an example embodiment, the communication devices 102.1-102.n may be a group of resources including a personal computer (PC), a tablet PC, a set-top box (STB), a Personal Digital Assistant (PDA), a mobile telephone, a portable music player (e.g., a portable hard drive audio device such as an MP3 player), a gaming device, a car audio device, a web appliance, a network router, switch or bridge, or any machine capable of executing a set of instructions (sequential or otherwise) that specify actions to be taken by that machine.

The network 104 may include a private network (e.g., a home or business network), a public network such as the Internet, an access network, or combinations of the private network, the public network and/or the access network. The network 104 may include a wired network such as a fiber, DSL, coaxial, and the like or a wireless network such as 802.11, BLUETOOTH network, mobile cellular, WiMAX, WiFi, and the like. In an example embodiment, the network 104 may transmit data by network based protocols (e.g., TCP/IP).

The source server 106 may include a web server 108, an application server 110, and/or a database server 112. The application server 110 may enable targeted communication (e.g., sending of targeted messages) and provide other functionality as described in greater detail below. The web server 108 may provide an interface to the source server 106 for the communication devices 102.1-102.n and may output data (e.g., a targeted message) from the source server 106 the communication devices 102.1-102.n.

In an example embodiment, the source server 106 may include a mail server coupled to the application server 110 and may send targeted messages over the network 104 and respond to data (e.g., requests for action) received from the communication devices 102.1-102.n.

The database server 112 may enable data to be stored on and/or retrieved from a database 114. For example, the database server 112 may access and retrieve information (e.g., in the form of data structures) regarding various performers, performance groups, events, users, and the like from the database 114.

A person seeking to communicate (e.g., to transmit a targeted message to the communication devices 102.1-102.n) with the source server 106 may utilize an interface device 116.1, 116.2 to communicate over the network 104 with the source server 106. The functionality of the interface devices 116.1, 116.2 may include the functionality of the communication devices 102.1-102.n

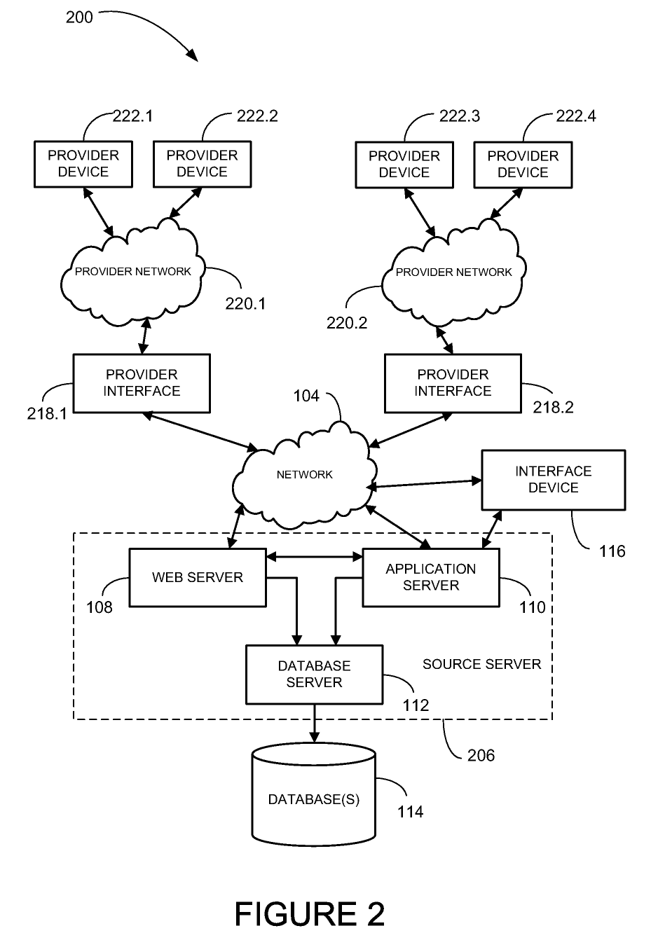

FIG. 2 illustrates a communication system 200 according to an example embodiment. One or more interface devices 116 may communicate over the network 104 with a source server 206. The source server 206 may include the web server 108, the application server 110, and/or the database server 112. The database server 112 may communicate with the database 114.

The source server 206 may communicate with one or more provider devices 222.1 through 222.4 by providing communications (e.g., sending a targeted message) to a provider interface 218.1, 218.2 through one or more provider networks 220.1, 220.2. For example, the provider networks 220.1, 220.2 may be mobile phone networks and the provider devices 222.1-222.4 may be mobile devices on the mobile phone networks.

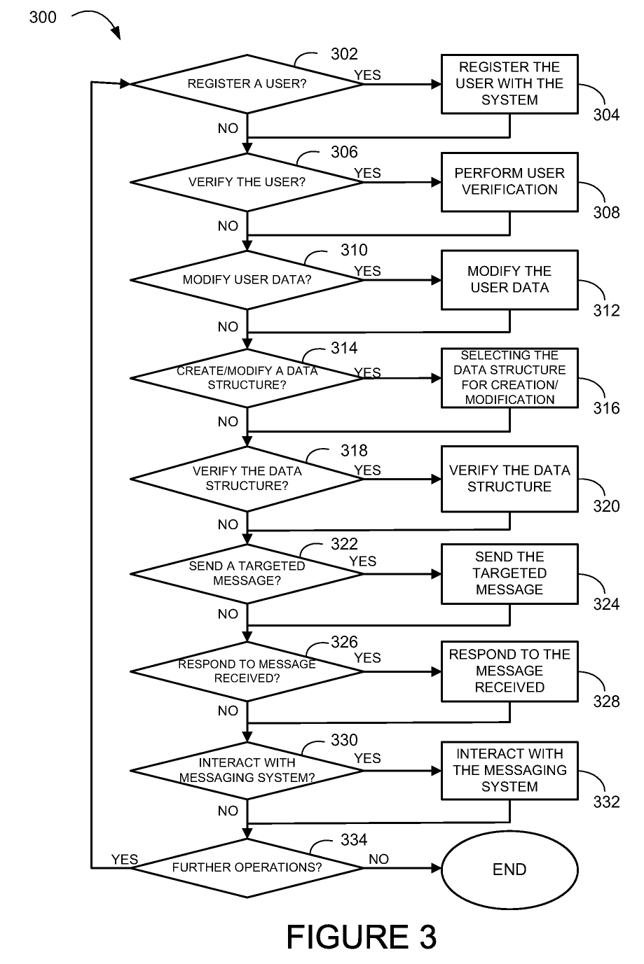

FIG. 3 illustrates a method 300 for processing user interaction with the source server 106, 206 (see FIGS. 1 and 2) according to an example embodiment.

A determination may be made at decision block 302 whether to register a user with the source server 106, 206. If the determination is made for the user to register, the user may register with the source server 106, 206 at block 304. For example, registering with the source server 106, 206 may include providing information to complete a user data structure for a user.

In an example embodiment, registering with the system may include the user providing communication type preferences so that the user may receive targeted messages from senders according to the communication type preferences. For example, the communication type preferences may include the user receiving all messages for a geographic area (e.g., St. Louis, Mo.), all messages for favorite system elements (e.g., a favorite venue such as UMB Bank Pavilion and a favorite performer group such as the St. Louis Blues hockey team), user specified system elements, and/or system generated system elements (e.g., as may be determined based on use of the source server 106, 206 by the user).

If the user is not registering with the source server 106, 206 at decision block 302 or after completing operations at block 304, the method 300 may proceed to decision block 306.

At decision block 306, a determination may be made whether to verify the user. For example, verifying the user may include sending a user a one time code and/or e-mail and receiving a response with the code and/or a response to the e-mail with a certain period of time. If the determination is made that the user is to be verified with the source server 106, 206, user verification may be performed at block 308. If the user is not being verified with the source server 106, 206 (e.g., the user is already verified or the user does not seek to be verified) or after completing the operations at block 308, the method 300 may proceed to decision block 310.

In an example embodiment, verifying the user may enable the user to have greater use of the functionality of the source server 106, 206, while unverified users may have more limited used of the functionality of the source server 106, 206.

A determination may be made at decision block 310 whether to modify user data of the user. If the user data is to be modified, the user data may be modified at block 312. For example, the user may change a display name, update an image associated with the user, or the like. If the user data is not to be modified at decision block 310 or after completing operations at block 312, the method 300 may proceed to decision block 314.

At decision block 314, a determination may be made whether to create and/or modify a data structure associated with the source server 106, 206. If the determination is made to create and/or modify a data structure, the data structure may be selected for creation and/or modification at block 316. An example embodiment of selecting the data structure for creation and/or modification is described in greater detail below. If the determination is made not to create and/or modify the data structure at decision block 314 or upon completing the operations at block 316, the method 300 may proceed to decision block 318.

A determination may be made at decision block 318 whether to verify a data structure. If the data structure is to be verified, the data structure may be verified at block 320. If a determination is made not to verify the data structure at decision block 318 or after completing operations at block 320, the method 300 may proceed to decision block 322.

At decision block 322, a determination may be made whether to send a targeted message. In an example embodiment, the targeted message may be a message sent to users of the source server 106, 206 based on expressed user interests that matches target criteria selected by a sender. For example, the sender of the message may not know identity (e.g., name and/or contact information) of some (or all) of the targets but may know a number of the users to which the message will be sent and that the targets have expressed interest in receiving messages of the communication type (e.g., regarding a location, venue or a performer group) being sent by the sender.

If the determination is made that the targeted message is to be sent, the targeted message may be sent at block 324. An example embodiment of sending the targeted message to targets (e.g., users of the source server 106, 206) is described in greater detail below. If it is determined that the targeted message is not to be sent at decision block 322 or after completing the operations at block 324, the method 300 may proceed to decision block 326.

A determination may be made at decision block 326 whether to respond to a message received. If a response is to be made to the message, a response may be made to the message at block 328. An example embodiment of responding to a message is described in greater detail below. If the response is not to be made to the message at decision block 326 or after completing operations at block 328, the method 300 may proceed to decision block 330.

At decision block 330, a determination may be made whether to have further interaction with the source server 106, 206. For example, further interaction with the source server 106, 206 may include browsing (e.g., viewing a data structure), searching (e.g., searching for one or more data structures based on key words), social networking, purchasing (e.g., concert tickets, CDs, DVDs, and other media), using the calendar, and the like.

In an example embodiment, further interactions may include a user providing a system code obtained from a source. In response to providing the system code, the user may receive information regarding the system element according to the system code data structure associated with the system code.

In an example embodiment, the source server 106, 206 may be used for targeted interaction including targeting messages, target searching, targeted user suggestions, targeted logging of users activity with the source server 106, 206, and the like. For example, targeted results provided as a result of targeted activity may be based on extrapolated user taggings, the popularity of an event, the proximity of a user to the event, and the like.

In an example embodiment, a tagging methodology to tag data structures and/or other content may be used within the source server 106, 206 to provide relevant results to the user.

If the determination is made that the interaction is to occur, the interaction may occur with the source server 106, 206 at block 332. If interaction is not to occur at decision block 330 or after completing the operations at block 332, the method 300 may proceed to decision block 334.

The method 300 may determine whether further operations with the source server 106, 206 are to be received. If further operations are to be received, the method 300 may return to decision block 302. If no further operations are to be received at decision block 334, the method 300 may terminate.

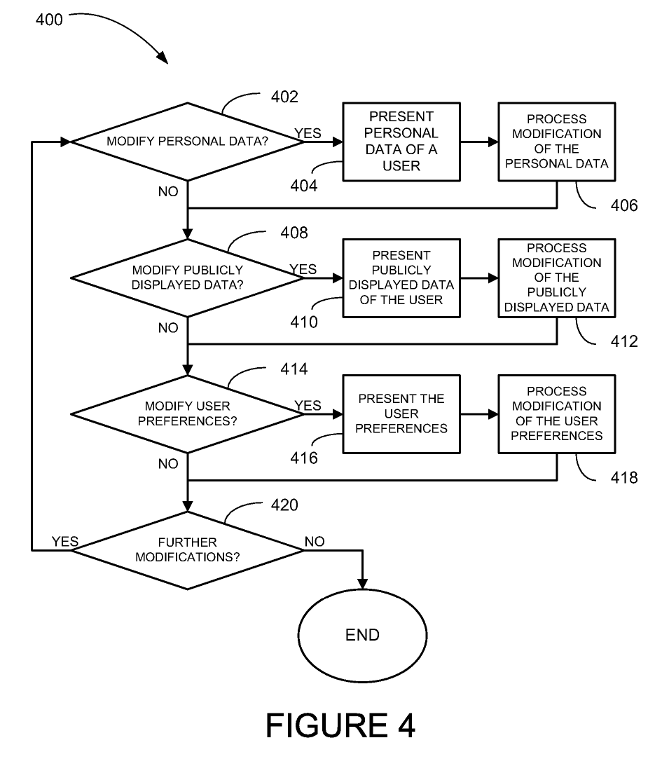

FIG. 4 illustrates a method 400 for modifying user data according to an example embodiment. In an example embodiment, the method 400 may be performed at block 312 (see FIG. 3).

A determination may be made at decision block 402 whether to modify personal data of the user. If the determination is made to make the modification, the personal data of the user may be presented at block 404 and modifications to the personal data may be processed at block 406. An example embodiment of displaying the personal data of the user is described in greater detail below. If a determination is made not to modify the personal data of the user at decision block 402 or upon completion of the operations at block 406, the method 400 may proceed to decision block 408.

At decision block 408, a determination may be made whether to modify publicly displayed data of the user. If the determination is made to make the modification, the publicly displayed data of the user may be presented at block 410 and modifications to the publicly displayed data may be processed at block 412. An example embodiment of displaying the publicly displayed data of the user is described in greater detail below. If a determination is made not to modify the publicly displayed data of the user at decision block 408 or upon completion of the operations at block 412, the method 400 may proceed to decision block 414.

A determination may be made at decision block 414 whether to modify user preferences of the user with the source server 106, 206. If the determination is made to make the modification, the user preferences of the user may be presented at block 416 and modifications to the user preferences may be processed at block 418. An example embodiment of displaying the user preferences of the user is described in greater detail below. If a determination is made not to modify the user preferences of the user at decision block 414 or upon completion of the operations at block 418, the method 400 may proceed to decision block 420.

At decision block 420, a determination may be made whether to perform further modifications on the user data. If further modifications are desired, the method 400 may return to decision block 402. If no further modifications are desired at decision block 420, the method 400 may terminate.

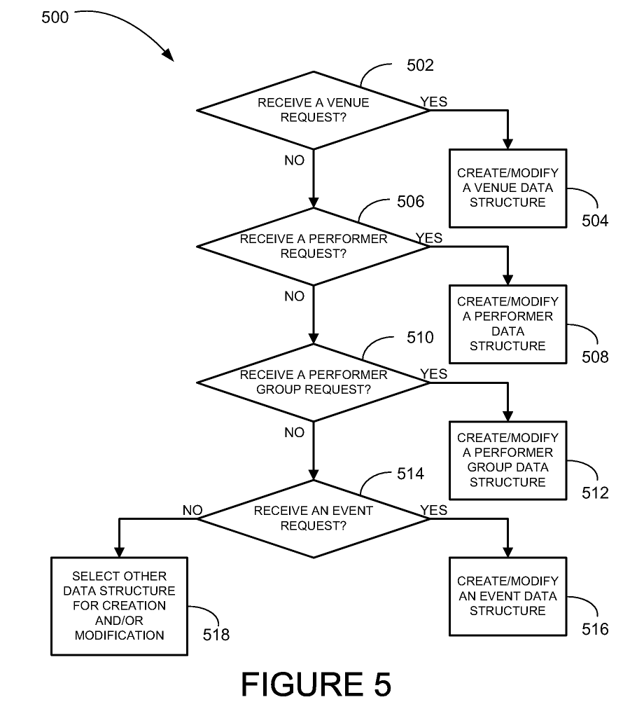

FIG. 5 illustrates a method 500 for selecting a data structure for modification according to an example embodiment. In an example embodiment, the method 500 may be performed at block 316 (see FIG. 3).

A determination may be made at decision block 502 as to whether a venue request for creating and/or modifying a venue data structure has been received. If the venue request has been received, the venue data structure of a selected venue may be created and/or modified at block 504. An example embodiment of creating and/or modifying a data structure is described in greater detail below. If the venue request has not been received, the method 500 may proceed to decision block 506.

At decision block 506, a determination may be made as to whether a performer request for creating and/or modifying a performer data structure has been received. If the performer request has been received, the performer data structure of a selected performer may be created and/or modified at block 508. An example embodiment of creating and/or modifying a data structure is described in greater detail below. If the performer request has not been received, the method 500 may proceed to decision block 510.

A determination may be made at decision block 510 as to whether a performer group request for creating and/or modifying the performer group data structure has been received. If the performer group request has been received, the performer group data structure of a selected performer group may be created and/or modified at block 512. An example embodiment of creating and/or modifying a data structure is described in greater detail below. If the venue performer group has not been received, the method 500 may proceed to decision block 514.

At decision block 514, a determination may be made as to whether an event request for creating and/or modifying an event data structure has been received. An example embodiment of creating and/or modifying a data structure is described in greater detail below.

If the event request has been received, the event data structure of a selected event may be created and/or modified at block 516. For example, the event may be created while the user is at the event by use of the communication device 102 (see FIG. 1). If the event request has not been received, another type of data structure may be selected for creation and/or modification at block 518. An example embodiment of creating and/or modifying data structures is described in greater detail below.

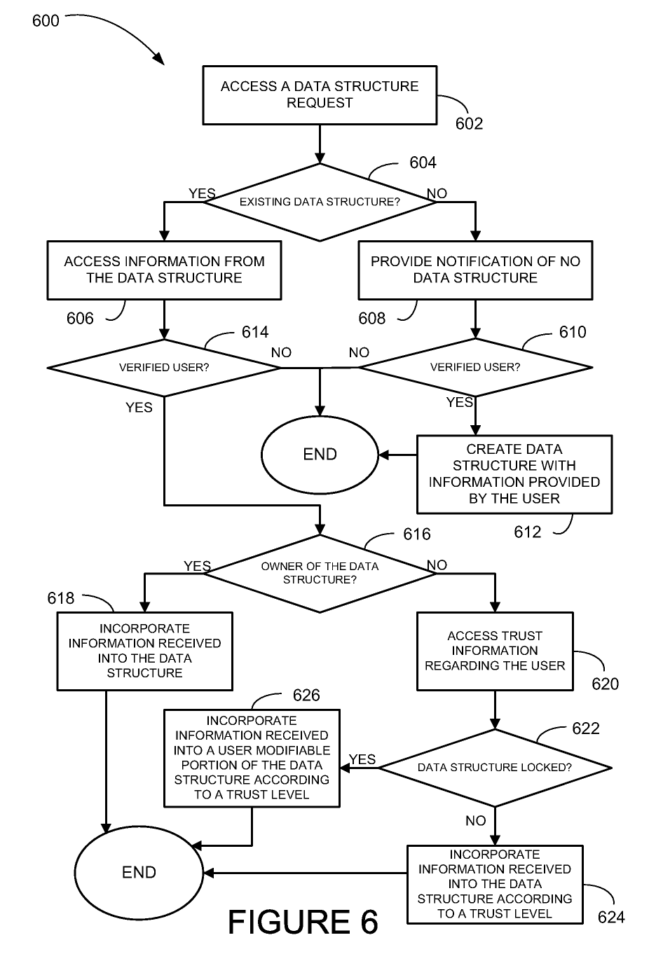

FIG. 6 illustrates a method 600 for creating and/or modifying a data structure according to an example embodiment. In an example embodiment, the method 600 may be performed at block 316, block 504, block 508, block 512, block 516 and/or block 518.

A data structure request may be accessed for a system element at block 602. The data structure request may be a request to create and/or modify a data structure associated with the system element. For example, a venue request may be a request to create and/or modify the venue data structure for a particular venue (e.g., a stadium), an event request may be a request to create and/or modify the event data structure for a particular event (e.g., a hockey game or a music concert), and the like.

At decision block 604, a determination may be made whether there is an existing data structure for the system element. If there is no data structure at decision block 604, a notification of no data structure may be provided at block 608. At decision block 610, a determination may then be made as to whether the user is a verified user of the source server 106, 206. If the user is not a verified user at decision block 610, the method 600 may terminate. If the user is a verified user, a data structure for a system element may be created with information regarding the system element provided by the user at block 612. In an example embodiment, the user need not be a verified user of the source server 106, 206 to create a new data structure for a new system element.

If there is the existing data structure for the system element at decision block 604, information may be accessed from the data structure at block 606. For example, the information of the data structure may be presented to the user. Example embodiments of presenting information from the data structure are described in greater detail below.

A determination may be made at decision block 614 whether the user is a verified user of the source server 106, 206. If the user is not a verified user at decision block 610, the method 600 may terminate. In an example embodiment, the user need not be a verified user of the source server 106, 206 to modify the existing data structure.

If the user is a verified user at decision block 614, a determination may be made at decision block 616 as to whether the user is an owner (e.g., the owner of the venue or a musician in a band) of the data structure. If the user is the owner of the data structure, information received from the user may be incorporated into the data structure at block 618. If the user is not the owner of the data structure, trust information for the user may be accessed at block 620. For example, the trust information of the user may indicate a trust level of the user within the source server 106, 206. In an example embodiment, the trust information may be based on contributions (e.g., number and/or quality) of a user to the source server 106, 206, abuse reports against the user, content (e.g., data structures, media and/or comments) submitted by the user that have been verified as accurate, and the like.

At decision block 622, a determination may be made as to whether the data structure has been locked (e.g., by an owner of the data structure and/or a system administrator of the source server 106, 206). If the data structure is not locked, information received from the user may be incorporated into the data structure according to a trust level of the user at block 624. For example, the trust level may indicate the changes that the user may make to the data structure. If the data structure is locked at decision block 622, information may be incorporated into a user modifiable portion of the data structure according to a trust level at block 626.

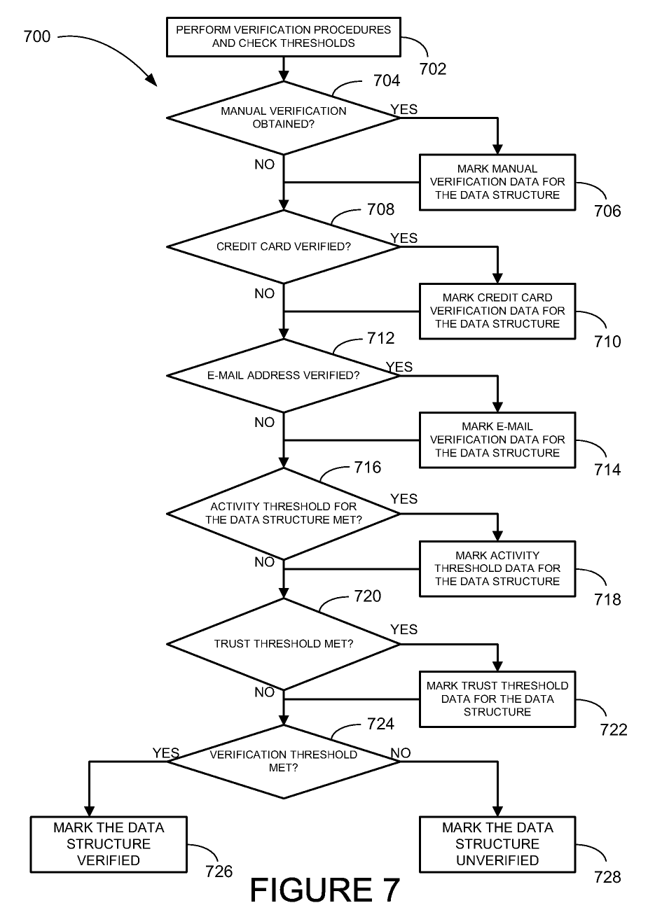

FIG. 7 illustrates a method 700 for verifying a data structure according to an example embodiment. In an example embodiment, the method 700 may be performed at block 320 (see FIG. 3).

One or more verification procedures may be performed and thresholds may be checked at block 702. For example, the verification procedures may include a manual verification procedure, a credit card verification procedure, an e-mail address verification procedure, and an activity threshold and a trust threshold may be checked to determine whether a verification threshold is met to verify the data structure.

A determination may be made at decision block 704 whether a manual verification of a data structure has been obtained. If the manual verification has been obtained, manual verification data may be marked for the data structure at block 706. If the manual verification has not been obtained at decision block 704 or upon completion of the operations at block 706, the method 700 may proceed to decision block 708.

At decision block 708, a determination may be made as to whether a credit card associated with the data structure has been verified. If the credit card associated with the data structure has been verified, credit card verification data may be marked for the data structure at block 710. If the credit card verification has not been obtained at decision block 708 or upon completion of the operations at block 710, the method 700 may proceed to decision block 712.

A determination may be made at decision block 712 whether an e-mail address associated with the data structure has been verified. If the e-mail address has been verified, the e-mail verification data may be marked for the data structure at block 714. If the e-mail verification has not been verified at decision block 712 or upon completion of the operations at block 714, the method 700 may proceed to decision block 716.

At decision block 716, a determination may be made as to whether an activity threshold for the data structure has been met. If the activity threshold has been met, activity threshold data may be marked for the data structure at block 718. If the activity threshold has not been met at decision block 716 or upon completion of the operations at block 718, the method 700 may proceed to decision block 720.

A determination may be made at decision block 720 as to whether a trust threshold has been met for the data structure. For example, the trust threshold may be that the trust level for the data structure meets and/or exceeds a trust level. If the trust threshold has been met, trust threshold data may be marked for the data structure at block 722. If the trust threshold has not been met at decision block 720 or upon completion of the operations at block 722, the method 700 may proceed to decision block 724.

At decision block 724, a determination may be made as to whether a verification threshold has been met. For example, the verification may be that the data structure has been marked for a certain number of verification data, a certain percentage of verification data, certain types of verification data, and the like. If the verification threshold is met, the data structure may be marked as verified at block 726. If the verification threshold is not met at decision block 724, the data structure may be marked as unverified at block 728.

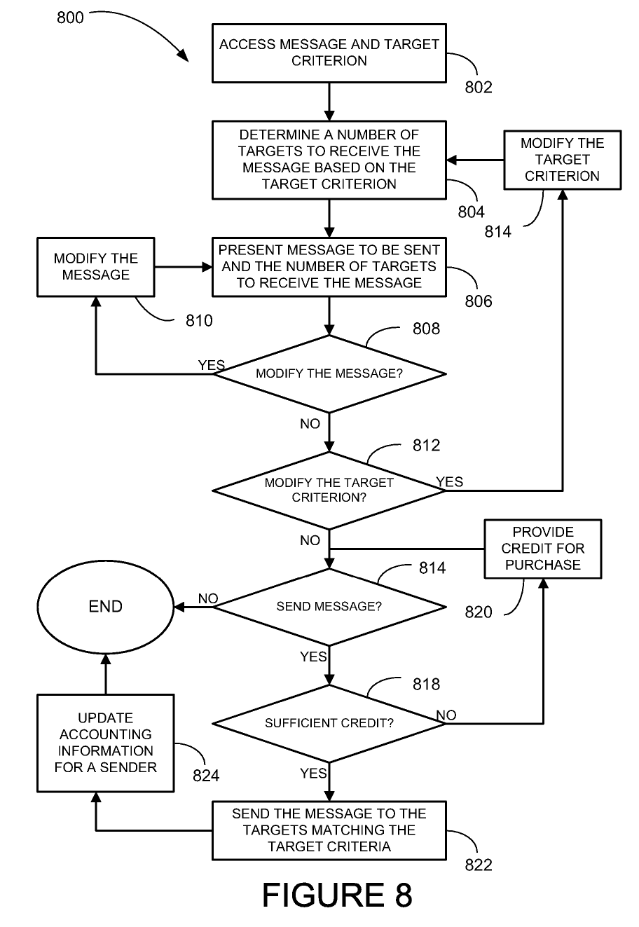

FIG. 8 illustrates a method 800 for sending a targeted message according to an example embodiment. In an example embodiment, the method 800 may be performed at block 324 (see FIG. 3).

A message and a target criterion may be accessed at block 802. For example, the target criterion may be based on interests of users as may be selected by the users and/or system generated (e.g., based on specified and/or determined preferences). A number of targets (e.g., users of the source server 106, 206 that meet the target criterion) to receive the message may be determined based on the target criterion selected by a sender (e.g., a user sending the targeted message) at block 804.

The message and the number of targets to receive the message may be presented to the sender at block 806. For example, the sender may be provided with a graphical representation indicating a number of targets in various geographic areas that may receive the message.

In an example embodiment, the sender may not be provided with identifying information as to identities of the number of targets (e.g., the targets may be anonymous to the sender), but may rather be provided with the number of targets that meet the target criterion.

At decision block 808, a determination may be made as to whether the sender seeks to modify the message. If the determination is made to modify the message, the message may be modified at block 810 and the method 800 may return to block 806. If the determination is made not to modify the message at decision block 808, the method 800 may proceed to decision block 812.

A determination may be made at decision block 812 as to whether the sender seeks to modify the target criterion. For example, the sender may seek to modify the target criterion (e.g., increase or decrease a region) to obtain more or less targets to receive the targeted message. In an example embodiment, the sender may tailor the target criterion to send the targeted message to a desired number of recipients that have specified an interest in a communication type the targeted message.

If the determination is made to modify the target criterion, the target criterion may be modified at block 814 and the method 800 may return to block 804. If the determination is made not to modify the target criterion at decision block 812, the method 800 may proceed to decision block 816.

At decision block 816, a determination may be made whether to send the message. If the message is not to be sent, the method 800 may terminate. If the message is to be sent, the method 800 may proceed to decision block 818,

A determination may be made at decision block 818 whether the user has sufficient credit (e.g., money in a user account with the source server 106, 206) to send the message to the targets according to the target criterion. If the sender does not have sufficient credit, the sender may be provided with an opportunity to purchase credit at block 820 and the method 800 may return to decision block 816. If the sender has sufficient credit at decision block 818, the message may be sent to the targets matching the target criterion at block 822 and accounting information for the sender may be updated at block 824. In an example embodiment, the message may include a system code of a system code field.

In an example embodiment, the message may be sent from a non-source identifier (e.g., a unique e-mail address) to enable any responses received to the message to be associated with the sent message. For example, responses received may be processed by the source server 106, 206 and may not be provided directly (or otherwise) to the sender of the targeted message.

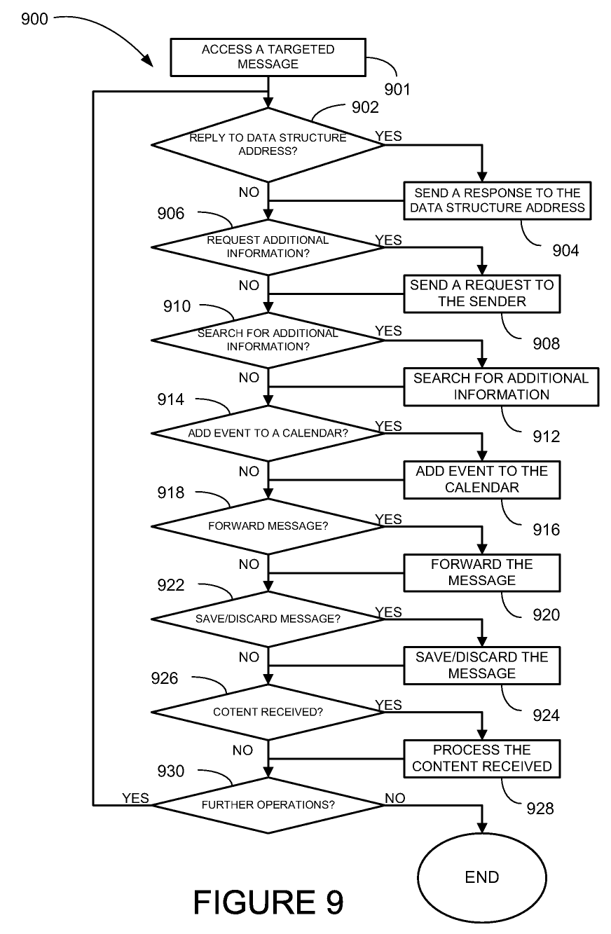

FIG. 9 illustrates a method 900 for responding to a targeted message according to an example embodiment. In an example embodiment, the method 900 may be performed at block 328 (see FIG. 3).

A targeted message may be accessed at block 901. For example, the targeted message may be sent by a sender to targets during the operations at block 822 (see FIG. 8). In an example embodiment, the targeted message may be sent from a non-source identifier (e.g., a unique e-mail address) to enable the response to the targeted message to be associated with data structures associated with the targeted message.

A determination may be made at decision block 902 whether to reply to a data structure address (e.g., an address associated with a data structure) associated with the targeted message. If the determination is made to reply to the targeted message, a response may be sent to the data structure address at block 904. If the determination is made not to reply at decision block 902 or upon completion of the operations at block 904, the method 900 may proceed to decision block 906.

A determination may be made at decision block 906 whether to request additional information (e.g., information beyond the information provided in the targeted message). If the determination is made to request additional information, a request for additional information may be sent (e.g., to the data structure address or a system address for the source server 106, 206 of FIGS. 1 and 2) at block 908. For example, the targeted message may be received in multiple parts such that a user may request additional information to receive a next part of the targeted message.

In an example embodiment, the additional information may be requested by a command to enable the source server 106, 206 to respond with appropriate information. For example, the command “directions” may enable the user to receive direction as the additional information.

If the determination is made not to request additional information at decision block 906 or upon completion of the operations at block 908, the method 900 may proceed to decision block 910.

A determination may be made at decision block 910 whether to search for additional information. For example, the user may search for additional information with the source server 106, 206 based on the system code provided in the targeted message. If the determination is made to search, the user may search for additional information at block 912. If the determination is made not to search at decision block 910 or upon completion of the operations at block 912, the method 900 may proceed to decision block 914.

At decision block 914, a determination may be made whether to add an event (e.g., as may be referenced in the targeted message) to a calendar of a user. If the determination is made to add the event to the calendar, the event may be added to the calendar at block 916. If the determination is made not to add the event to the calendar at decision block 914 or upon completion of the operations at block 916, the method 900 may proceed to decision block 918.

A determination may be made at decision block 918 whether to forward the targeted message. If the determination is made to forward the targeted message, the targeted message may be forward to other users (e.g., as may be predefined by the user in user preferences) of the source server 106, 206 at block 920. If the determination is made not to forward the targeted message at decision block 918 or upon completion of the operations at block 920, the method 900 may proceed to decision block 922.

At decision block 922, a determination may be made whether to save and/or discard the targeted message. If the determination is made to save and/or discard the targeted message, the targeted message may be saved and/or discard at block 924. If the determination is made not to save and/or discard the targeted message at decision block 922 or upon completion of the operations at block 924, the method 900 may proceed to decision block 926.

A determination may be made at decision block 926 as to whether content (e.g., data structures, media, and/or comments) have been received. If content has been received in response to the targeted message, the content received may be processed at block 928.

In an example embodiment, comments received from a verified user may be associated with one or more data structures associated with the targeted message as described in greater detail above. In an example embodiment, data structures received from a verified user may be added to the source server 106, 206 as described in greater detail above. An example embodiment of processing the media received is described in greater detail below.

If content has not been received in response to the targeted message at decision block 926 or upon completion of the operations at block 928, the method 900 may proceed to decision block 930.

At decision block 930, a determination may be made as to whether there are further operations of the method 900. If there are further operations, the method 900 may return to decision block 902. If there are no further operations at decision block 930, the method 900 may terminate.

In an example embodiment, a user may select a data structure for modification in response to a targeted message during the operations of the method 900.

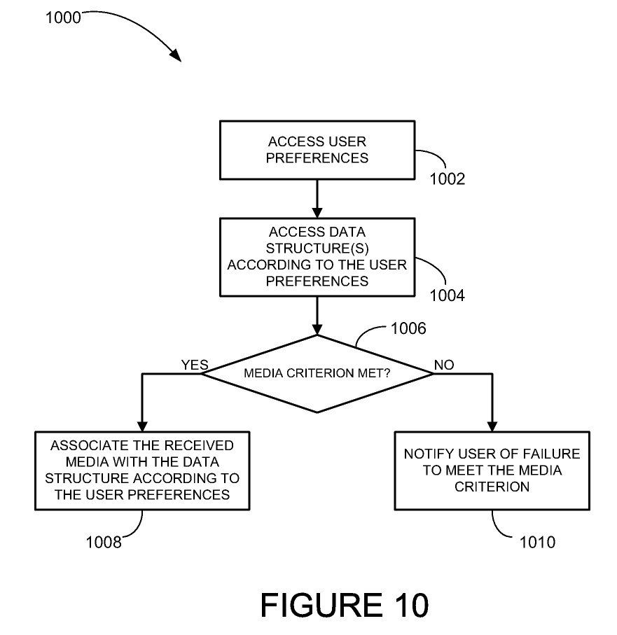

FIG. 10 illustrates a method 1000 for processing received content according to an example embodiment. In an example embodiment, the method 1000 may be performed at block 928 (see FIG. 9).

User preferences for a user that seeks to make media available on the source server 106, 206 may be accessed at block 1002. For example, the user preferences may indicate which data structures the user would like the media to be associated. One or more data structures with which the media may be associated according to the user preferences may be accessed at block 1004.

At decision block 1006, a determination may be made as to whether media criterion has been met. For example, the media criterion may include whether the media is adult material, in the correct file format, copyright, not a certain type of file (e.g., a uniform resource locator), and/or whether one or more of the data structures to which the media is desired to be associated with are locked.

If a determination is made that the media criterion is met, the received media may be associated with the data structure according to user preferences at block 1008. For example, the user preferences may identify the data structures for which the received media should be identified. If a determination is made that the media criterion is not met at decision block 1006, the user may be notified of a failure to meet the media criteria at block 1010.

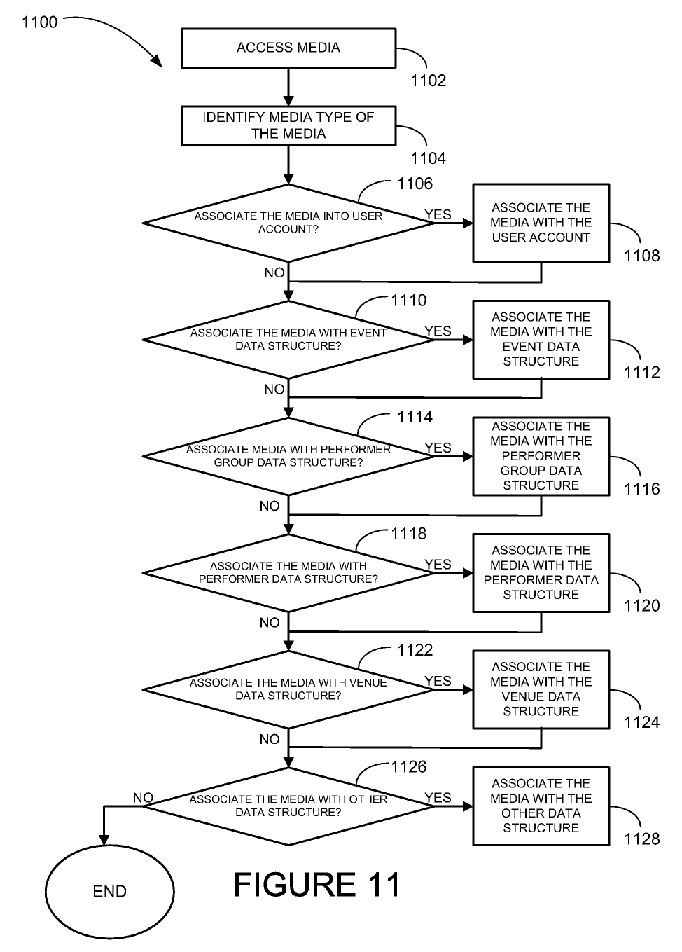

FIG. 11 illustrates a method 1100 for associating media with one or more data structures according to an example embodiment. In an example embodiment, the method 1100 may be performed at block 1008 (see FIG. 10).

Media may be accessed at block 1102 and a media type of the media may be identified at block 1104. For example, the media type may be pictures, audio, video, and the like.

At decision block 1106, a determination may be made as to whether the media should be associated with the user account. For example, the media may be associated with the user account when the user seeks to make the media available to the user and/or other users of the source server 106, 206. If the determination is made to associate the media, the media may be associated into the user account at block 1108. If the determination is made not to associate the media with the user account at decision block 1106, the method 1100 may proceed to decision block 1110.

A determination may be made at decision block 1110 whether to associate the media with the event data structure. For example, the media may be associated with the event data structure so that when users of the source server 106, 206 view a specific venue associated with the event data structure, the users may be presented with the media. If the determination is made to associate the media, the content may be associated with the event data structure at block 1112. If the determination is made not to associate the media with the event data structure at decision block 1110 or upon completion of the operations at block 1112, the method 1100 may proceed to decision block 1114.

At decision block 1114, a determination may be made whether to associate the media with the performer group data structure. For example, the media may be associated with the performer group data structure so that when users of the source server 106, 206 view a specific performer group associated with the performer group data structure, the users may be presented with the media. If the determination is made to associate the media, the media may be associated with the performer group data structure at block 1116. If the determination is made not to associate the media with the performer group data structure at decision block 1114 or upon completion of the operations at block 1116, the method 1100 may proceed to decision block 1118.

A determination may be made at decision block 1118 whether to associate the media with a performer data structure. For example, the media may be associated with the performer data structure so that when users of the source server 106, 206 view a specific performer associated with the performer data structure, the users may be presented with the media. If the determination is made to associate the media, the media may be associated with the performer data structure at block 1120. If the determination is made not to associate the media with the performer data structure at decision block 1118 or upon completion of the operations at block 1120, the method 1100 may proceed to decision block 1122.

At decision block 1122, a determination may be made whether to associate the media with a venue data structure. For example, the media may be associated with the venue data structure so that when users of the source server 106, 206 view a specific venue associated with the venue data structure, the users may be presented with the media. If the determination is made to associate the media, the media may be associated with the venue data structure at block 1124. If the determination is made not to associate the media with the venue data structure at decision block 1122 or upon completion of the operations at block 1124, the method 1100 may proceed to decision block 1126.

A determination may be made at decision block 1126 whether to associate the media with one or more other types of data structures. For example, the media may be associated with the location data structure and/or the performance data structure so that when users of the source server 106, 206 view a specific system element associated with the data structure, the users may be presented with the media. If the determination is made to associate the media, the media may be associated with the data structure at block 1128. If the determination is made not to associate the media with the data structure at decision block 1126 or upon completion of the operations at block 1120, the method 1100 may terminate.

In an example embodiment, by default and/or as defined by the user in user preferences the media may be associated with the user account, the event data structure, the performer group data structure, the venue data structure, and/or data structures.

In an example embodiment, media (e.g., for a particular event) may be ordered for presentation based on a date and/or time of submission of the media as opposed to EXIF data of the picture. The ordering may enable other users to track the progression of a particular event. The pictures may be further grouped (e.g., by the hour) to enable context to be provided to the media.

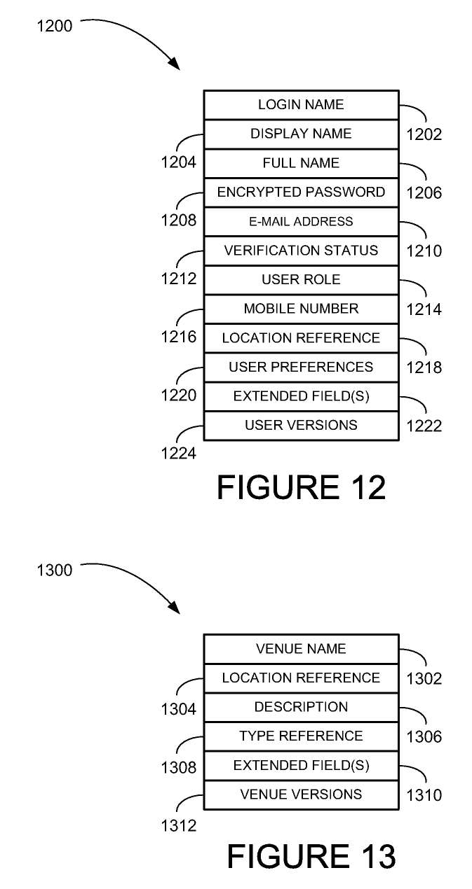

FIG. 12 illustrates an example user data structure 1200 according to an example embodiment. Each user data structure 1200 may retain information regarding a certain user of the source server 106, 206 and may be retained with the database 114 (see FIG. 1).

The user data structure 1200 may include a login name field 1202, a display name field 1204, and a full name field 1206. The login name field 1202 may be a name used by the user to access the source server 106, 206. The display name field 1204 may indicate a name under which the user may be identified to other users interacting with the source server 106, 206. The full name field 1206 may indicate the full name of the user.

An encrypted password field 1208 may retain a password of the user to access the source server 106, 206 in an encrypted form. An e-mail address field 1210 may retain an e-mail address provided by the user for which communication (e.g., targeted messages) may be received from the source server 106, 206.

A verification status field 1212 may indicate whether the user has been verified within the source server 106, 206. For example, the verification status field 1212 may indicate whether a mobile number in a mobile number field 1216 and/or an e-mail address within the e-mail address field 1210 has been verified by the source server 106, 206.

A user role field 1214 may indicate one or more roles for a role within the source server 106, 206. For example, roles for a user may include user, administrator, developer, blacklisted, and the like. Each role may have more than one level within the role, where each level has a higher level of access and/or trust.

A mobile number field 1216 may include a mobile device identifier unique to the user. In various embodiments, the identifier may include a mobile number, a text message identifier, an email address, or the like.

A location reference field 1218 may provide a reference to a location data structure. For example, the location data structure may describe an address, latitude and longitude, a geographic region, and the like for the user data structure 1200. An example of the location data structure is described in greater detail below.

A user preferences field 1220 may retain one or more preferences of the user. For example, communication preferences, display preferences, privacy preference, system preferences, and the like may be retained within the user preferences field 1220.

An extended fields data structure 1222 may include one or more extended fields for additional information provided by the user. An example embodiment of the extended fields data structure 1222 is described in greater detail below.

A user versions field 1224 may retain previous versions of the user data structure 1200 to enable a user and/or an administrator to access a prior user data structure 1200. For example, the prior user data structure 1200 may be accessed when a user indicates that the fields of the user data structure have been modified without the user's authorization.

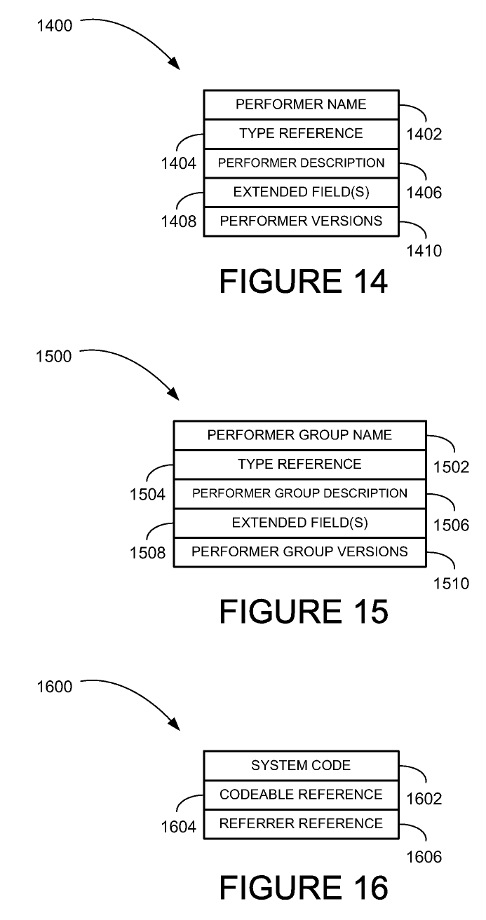

FIG. 13 illustrates an example venue data structure 1300 according to an example embodiment. The venue data structure 1300 may identify a venue (e.g. a system element of a venue type) available within the source server 106, 206 and/or may be stored within the database 114 (see FIG. 1).

The venue data structure 1300 may include a venue name field 1302 to retain a name of a venue. A location reference field 1304 may identify a location in which the venue is located by referencing a location data structure. An example embodiment of a location data structure is described in greater detail below.

A description field 1306 may contain a written description of the venue and provide other information regarding the venue to a user viewing the venue through use of the source server 106, 206. A type reference field 1308 may indicate a type of the venue by referencing to a type data structure. In an example embodiment, the type data structure may identify a variety of types of system elements (e.g., a concert hall, a club, or a stadium for a venue).

An extended fields data structure 1310 may include one or more extended fields to provide additional information as defined by the user of the source server 106, 206 regarding the venue. An example embodiment of the extended fields data structure 1310 is described in greater detail below. A venue versions field 1312 may retain previous versions of the venue data structure 1300 prior to modifications.

In an example embodiment, a venue group data structure may associate venues together by referencing venue data structures 1300 together. For example, the venue data structures 1300 may represent a chain of restaurants (e.g., The Ocean Basket restaurants), a chain of venues (e.g., the House of Blues concert clubs), and the like.

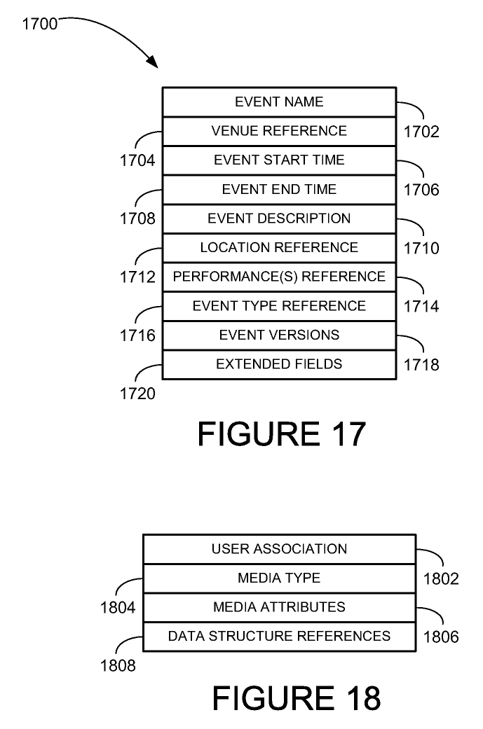

FIG. 14 illustrates an example performer data structure 1400 according to an example embodiment. The performer data structure 1400 may identify a performer (e.g. a system element of a performer type) available within the source server 106, 206 and/or may be stored within the database 114 (see FIG. 1). The performer may identify a musician (e.g., Zakk Wylde), an athlete (e.g., Albert Pujols), a comedian (e.g., Dave Chappelle), a speaker (e.g., Bill Clinton) or the like.

The performer data structure 1400 may include a performer name field 1402 which may provide a name of the performer. A type reference field 1404 may provide a reference to a data structure identifying a performer type (e.g., musician, comedian, athlete, or speaker) of the performer. A performer description field 1406 may provide information (e.g. a biography) regarding the performer.

An extended fields data structure 1408 may include one or more extended fields to provide additional information as defined by the user of the source server 106, 206 regarding the performer. An example embodiment of the extended fields data structure 1408 is described in greater detail below. A performer versions field 1410 may retain previous versions of the performer data structure 1400.

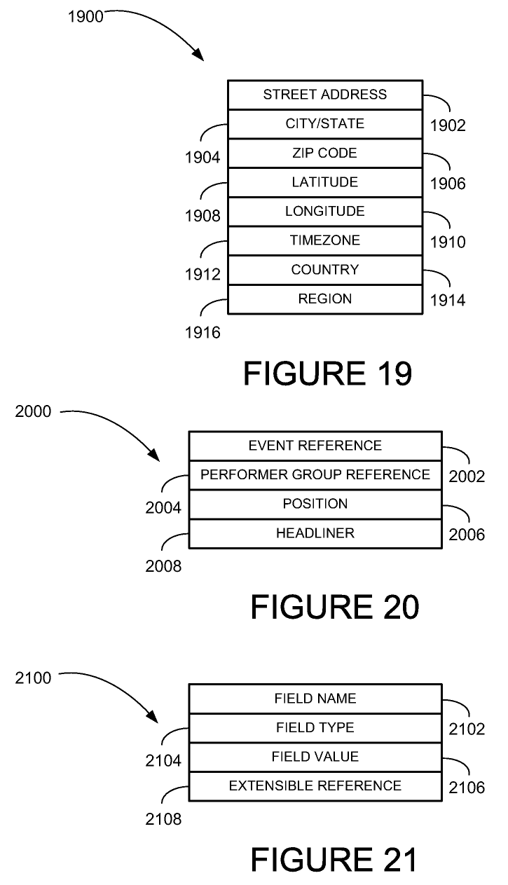

FIG. 15 illustrates an example performer group data structure 1500 according to an example embodiment. The performer group data structure 1500 may identify a performer group (e.g. a system element of a performer group type) available within the source server 106, 206 and/or may be stored within the database 114 (see FIG. 1). The performer group data structure 1500 may represent a band, a comedy group, a sports team, speakers at a presentation, and the like.

The performer group data structure 1500 may include a group name field 1502. The group name field 1502 may identify a group name (e.g., the St. Louis Cardinals) of the group. A type reference field 1504 may indicate a group type of the group. A group description field 1506 may provide a written description of the group.

An extended fields data structure 1508 may include one or more extended fields to provide additional information as defined by the user of the source server 106, 206 regarding the performer group. An example embodiment of the extended fields data structure 1508 is described in greater detail below. For example, the extended fields 1508 may indicate when the performer group was established, the number of members in the performer group, a genre of the music performed by the performer group, awards won by the performer group, and the like. A group versions field 1510 may retain previous versions of the performer group data structure 1500.

In an example embodiment, more than one performer (e.g., members of a band) from the performer data structures 1500 may be part of a single performer group (e.g., the band of which the members are a part) defined by the performer group data structure 1500. Each performer may be a member of more than one performer group. For example, a reference (e.g., a table) may associate each of the performer data structures 1500 to one or more of the performer group data structures 1500.

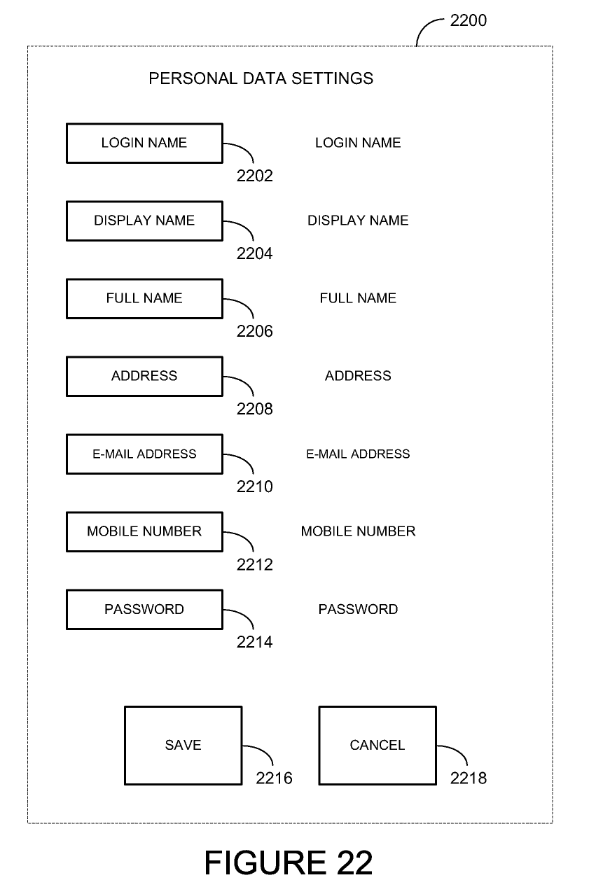

FIG. 16 illustrates an example system code data structure 1600 according to an example embodiment. The system code data structure 1600 may be used to identify communication to, from and between the source server 106, 206 and/or may be stored in the database 114 (see FIG. 1).

The system code data structure 1600 may include a system code field 1602, a codeable reference field 1604, and a referrer reference field 1606. The system code field 1602 may identify a system code within the source server 106, 206. The system code may be a number of digits (e.g., six digits) that may be used to identify one or more codeable data structures within the source server 106, 206. For example, the system code may be used during communication to identify data structures associated with the communication.

A codeable reference field 1604 may identify a codeable data structure (e.g., a data structure with an associated code). For example, codeable data structures may include the venue data structure 1300, the performer data structure 1400, the performer group data structure 1500, and/or an event data structure (see FIGS. 13-16).

A referrer reference field 1606 may indicate a referrer of the system code. For example, multiple system codes may refer to a same codeable data structure to enable tracking of a source of the system code. For example, St. Louis Sound Magazine may be a first referrer and include a first reference code for an event, Pollstar may be a second referrer and include a second reference code for the event, and a website implementing the source server 106, 206 may be a third reference and include a third reference code.

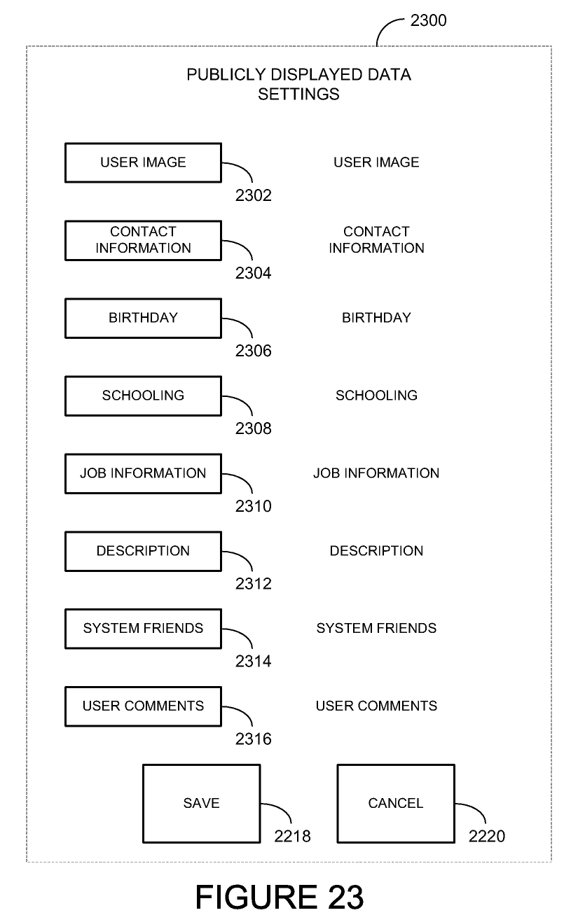

FIG. 17 illustrates an example event data structure 1700 according to an example embodiment. The event data structure 1700 may identify an event (e.g. a system element of an event type) available within the source server 106, 206 and/or may be stored within the database 114 (see FIG. 1).

The event data structure 1700 may include an event name field 1702, which may identify a name of the event. A venue reference field 1704 may identify the venue data structure 1300 (see FIG. 13) associated with the event. An event start time field 1706 may indicate a start time of the event. An event end time field 1708 may indicate an end time of the event. An event description field 1710 may provide a written description of the event. A location reference field 1712 may reference to a location data structure to provide a location for the event.

A performances reference field 1714 may associate one or more performances (e.g., by one or more performance groups) with the event. An example embodiment of the performance data structure for each of the one or more performances is described in greater detail below.

An event type reference field 1716 may indicate an event type (e.g., a musical event or a sporting event). An event versions field 1718 may retain previous versions of the event data structure 1700.

An extended fields data structure 1720 may include one or more extended fields to provide additional information as defined by the user of the source server 106, 206 regarding the event. An example embodiment of the extended fields data structure 1720 is described in greater detail below. For example, the extended fields may include an age requirement for the event (e.g., 18 and older).

In an example embodiment, an event group data structure may be used to associate events together by referencing event data structures 1700 together. For example, the event data structures 1700 may represent a number of shows that a band plays on a tour, a number of games that a sports team plays in a season, and the like.

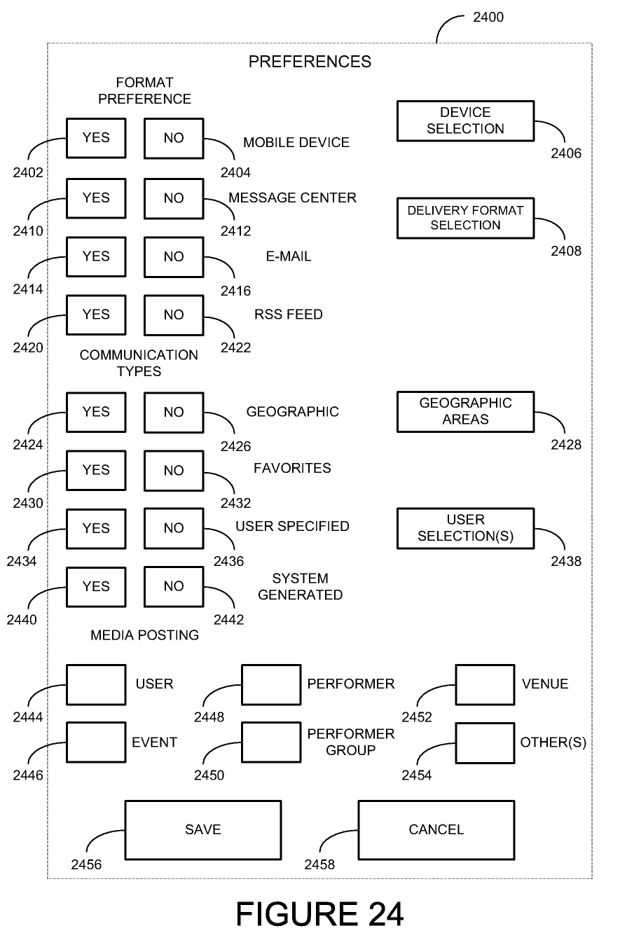

FIG. 18 illustrates an example media data structure 1800 according to an example embodiment. The media data structure 1800 may identify content of a media type that may be available within the source server 106, 206 and/or stored within the database 114 (see FIG. 1).

The media data structure 1800 may include a user association field 1802 to identify a user that provided the media (e.g., a photograph, a video clip, an audio clip, and other types of binary data). A media type field 1804 may indicate a media type of the media. A media attributes field 1806 may indicate attributes (e.g., length of a video clip, quality of the video clip, format of the audio clip, file size, and file width) of the media.

A data structure references field 1808 may indicate data structures with which the media is associated. An example embodiment of a method for associating media with data structures is described in greater detail below. In an example embodiment, an optional caption field of the media data structure 1800 may include a caption (e.g., a description of the media) submitted by a user of the source server 106, 206.

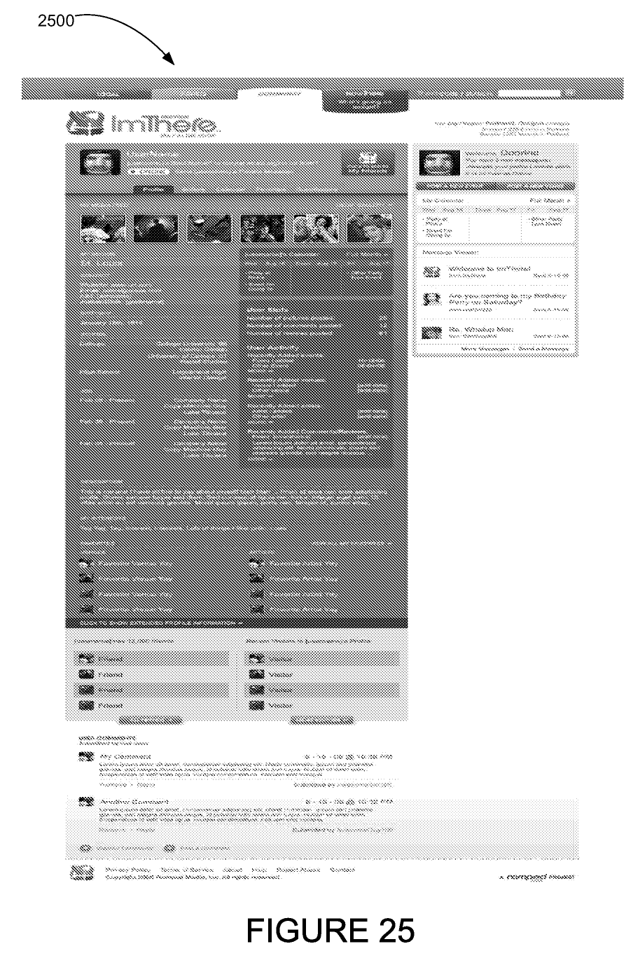

FIG. 19 illustrates a location data structure 1900 according to an example embodiment. The location data structure 1900 may identify a location (e.g. a system element of a location type) available within the source server 106, 206 and/or may be stored within the database 114 (see FIG. 1).

In an example embodiment, the location data structure 1900 may be referenced by the user data structure 1200, the venue data structure 1300, and/or the event data structure 1700 (see FIGS. 12, 13, and 13).

The location data structure 1900 may include a street address field 1902, a city/state field 1904, and a zip code field 1906 to provide an address for a system element associated with the location data structure 1900. A latitude field 1908 and a longitude field 1910 may provide latitude and longitude for the data structure (e.g., as may be obtained and/or used with a global positioning system (GPS) device) associated with the location data structure 1900. A time zone field 1912 may indicate the time zone of the address. A country field 1914 may indicate a country of the system element associated with the location data structure 1900. A region reference 1916 may identify a region in which the system element associated with the location data structure 1900 is located. In an example embodiment, one or more fields of the location data structure 1900 may be combined together.

It may be appreciated the location data structure 1900 or portions thereof may be made integral with other data structures used within the source server 106, 206 and/or stored in the database 114.

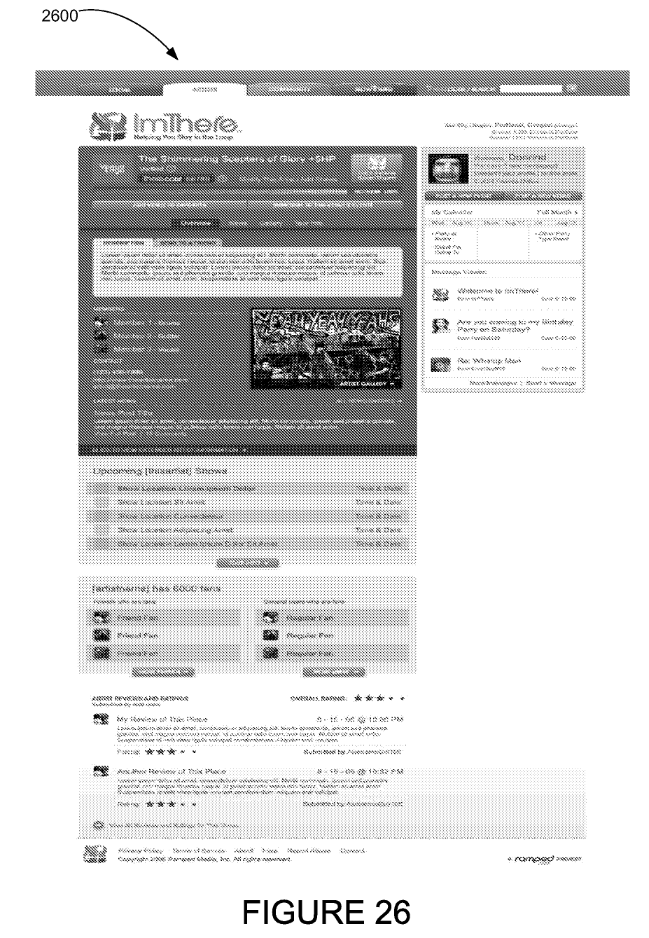

FIG. 20 illustrates a performance data structure 2000 according to an example embodiment. The performance data structure 2000 may identify a performance (e.g. a system element of a performance type) available within the source server 106, 206 and/or may be stored within the database 114 (see FIG. 1).

The performance data structure 2000 may include an event reference field 2002 that may reference the performance data structure 2000 to the event data structure 1700 (see FIG. 17). For example, if two different bands are playing an event, two different performance data structures 2000 may be referenced to the event data structure 1700.

A performer group reference field 2004 may reference one or more performer group data structures 1500 (see FIG. 15) to identify the performer groups associated with a performance. A position field 2006 may indicate a position (e.g., opener, headliner, or timeslot) of the performance group within the performance. A headliner field 2008 may indicate whether the performance is a headlining performance.

In an example embodiment, the data structures may include counts to indicate a number of users involved with a system identifier (e.g., a number of users at an event or a number of users subscribing to messages from a performer group). For example, a users going count may be included in the event data structure 1700 to include a number of users attending the event, a number of referrals count may be included in the in the system code data structure 1600, an address count may be included in the location data structure 1900 to indicate a number of system elements located at an address, a venues count field may be included in the location data structure 1900 to indicate a number of venues at the address, a users count field in the location data structure 1900 may indicate a number of users associated with an address, and the like. For example, the performance data structure may include a cache of users that have indicated in their calendar that they plan to attend an event.

In an example embodiment, the performance data structure 2000 may indicate who is performing at an event and their respective position within the event. For example, a performance may include a single performer group, but an event may have more than performance associated. For example, if an event has two different bands playing, two different performance data structures 2000 would associate the bands with the event.

In an example embodiment, the data structures may be implemented as objects within the source server 106, 206. In an example embodiment, the data structures may be implemented as tables within the source server 106, 206. Other implementations of the data structures may also be used.

In an example embodiment, an identification number may be used to reference a first data structure to a second data structure. However, other references including pointers may be used to reference the first data structure to the second data structure.

In an example embodiment, a versions field may retain and associate prior versions of a data structure with a current version of the data structure. For example, a versioning that enables viewing of a prior version and the user that made the modification may be used.

In an example embodiment, an experiences data structure may be used to associate the system elements that the user has experienced. For example, the experiences data structure may identify the performer groups which the user has seen perform and the events that the user has attended.

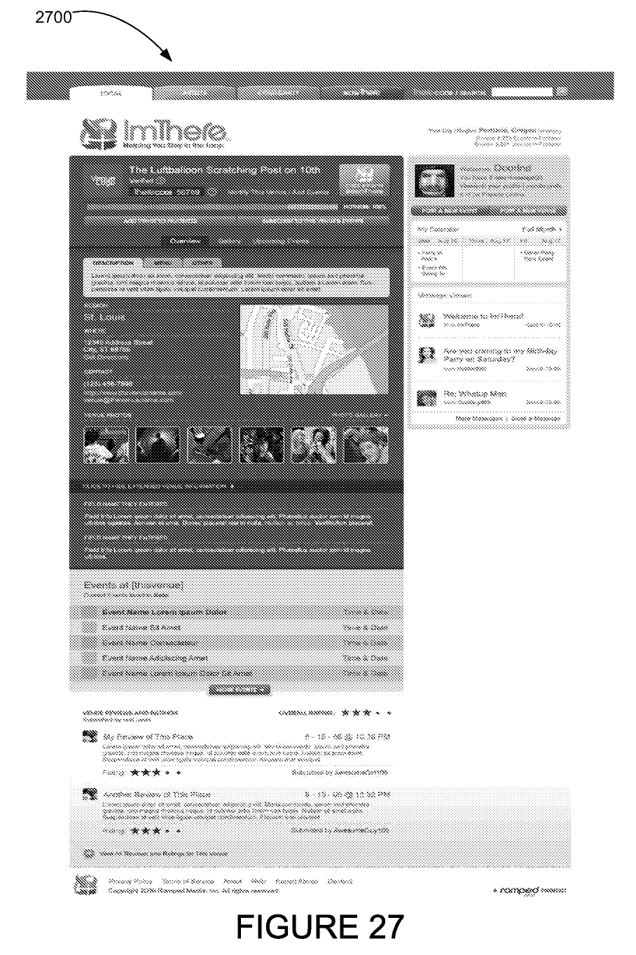

FIG. 21 illustrates an extended field data structure 2100 according to an example embodiment. In an example embodiment, the extended fields data structure 1222, extended fields data structure 1310, extended fields data structure 1408, extended fields data structure 1508, extended fields data structure 1720 (see FIGS. 12-15 and 17) may include the functionality of one or more of the extended field data structure 2100.

The extended fields data structure 2100 may associate additional information regarding system elements associated with their data structures. For example, each extended field data structure 2100 of the extended fields data structure (e.g., the extended fields data structure 1222 of FIG. 12) may be used in place of optional data fields (e.g., the user's birthday, school, AIM screen name, web site, and the like) within the data structures (e.g., the user data structure 1200).

In an example embodiment, the extended field data structure 2100 may have a field name 2102 to describe the field (e.g., date established), a field type 2104 (e.g., date), and a field value 2106 (e.g., May 5, 2000) that may be specified by a user of the system. The field name may be a text descriptor identifying the data the field contains. An extensive reference field 2108 may provide a reference to a data structure with extended fields (e.g., an extensible data structure).

A data type of the extended field data structure 2100 may affect properties of the source server 106, 206 associated with handling the extended field data structure 2100. For example, for an extended field of a given data type, the field's data type may affect options that a user sees to input the field value 2106; validate that the input is of the specified field type 2104; or generate forms of the field's value for storage in the database 114, display html to show on a page, or input html to modify the value. For example, a date extended field type (e.g., as may be appropriate for a ‘birthday’ extended field) may present user input options for selecting a year, a month, and a day of the month. The source server 106, 206 may validate (e.g., based on the extended field data structure 2100 data type of ‘date’) that the year is valid, the month is between 1 and 12, and the date is between 1 and the number of days in that month, and may display the date in a readable form (e.g., “Apr. 13, 1984”). A text extended field type may present the user with a field to input text and may perform no validation of the input text. A uniform resource locator (URL) extended field type may present a same text box as the text extended field type, but may validate that the input text is formed as a URL and link to the URL for HTML display. A number data extended field type may also present a text box and may validate that the input text is numeric and may be parsed into a real number. Other system-defined and nonsystem-defined extend field types may also be used.

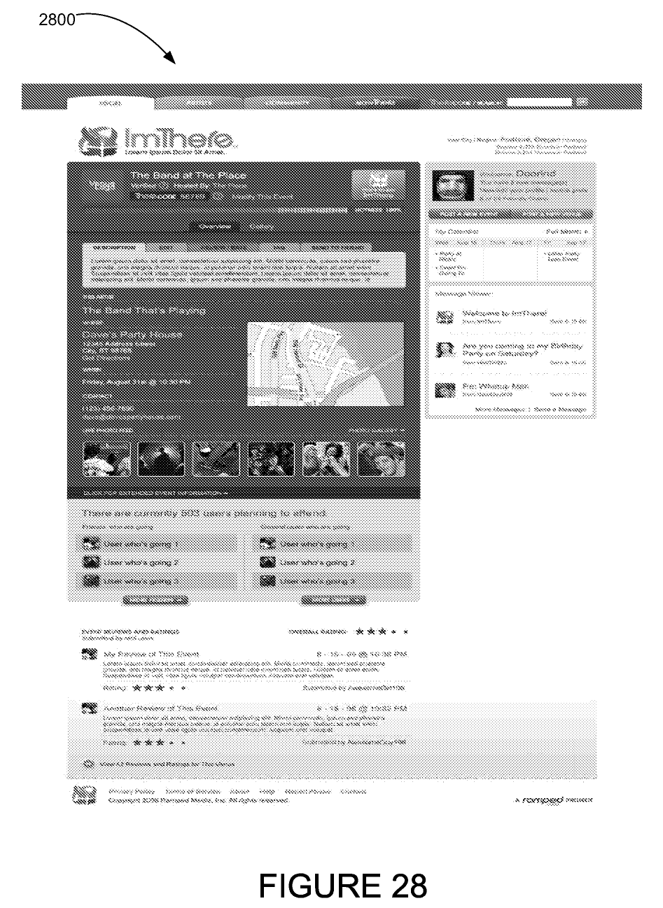

FIG. 22 illustrates an example user interface 2200 according to an example embodiment. In an example embodiment, the personal data settings presented at block 404 (see FIG. 4) may include the user interface 2200.

The user interface 2200 may include enable a user to specify a login name at a login name field 2202, a display name at a display name field 2204, and a full name at a full name field 2206. For example, the login name may be a name used to log into the source server 106, 206, the display name may be a name used (e.g., as may be known by others) within the source server 106, 206, and the full name may be a first name, a last name and a middle name and/or middle initial of the user. In an example embodiment, the login name specified in the login name field 2202 may be stored in the login name field 1202 (see FIG. 12), the display name specified in the display name field 2204 may be stored in the display name field 1204, and the full name specified in the full name field 2206 may be stored in the full name field 1206.

An address field 2208 may enable the user to specify a mailing address for the user. For example, the mailing address may be associated with the user data structure 1200 through the use of fields (e.g., the street address field 1902, the city/state field 1904, the zip code field 1906, and/or the country field 1914) of the location data structure 1900.

The user may specify an e-mail address at which the user may receive targeted messages and other communications with an e-mail address field 2210. For example, the e-mail address may be specified in the e-mail address field 1210.

The user may specify a mobile number at which the user may receive targeted messages and other communications with a mobile number field 2212. For example, the mobile number may be specified in the e-mail address field 1216. In an example embodiment, the user may specify a provider (e.g., Sprint Nextel) of the mobile number with the user interface 2200 and the information may be stored in the user data structure 1200.

A password may be selected by the user and specified in the password field 2214. The user may not be presented with a current password when viewing the user interface 2200. In an example embodiment, the password of the password field 2214 may be stored in an encrypted form in the encrypted password field 1208.

The user may choose to save changes to the personal data settings of the user by entering a new value into the fields 2202-2214 and selecting a save selection 2216, or may cancel saving changes to the fields 2201-2214 by selecting a cancel selection 2218.

FIG. 23 illustrates an example user interface 2300 according to an example embodiment. In an example embodiment, the publicly displayed data settings presented at block 410 (see FIG. 4) may include the user interface 2300. An example embodiment of the user interface 2300 is described in greater detail below.

A user may select a user image associated with the user at a user image field 2302.

The user may specify contact information for the user at a contact information field 2304. The user may provide a birthday for the user at a birthday field 2306. The user may provide schooling information of the user at a schooling field 2308. The user may provide job information of the user at a job field 2310.

The user may provide a description to be read by other users of the source server 106, 206 at a description field 2312. The user may specify friends within the source server 106, 206 at a system friends field 2314. Comments made by other users of the source server 106, 206 may be presented in a user comments field 2316.

In an example embodiment, the values contained within the fields 2302-2316 may be stored in the extended fields data structure 1222 of the user data structure 1200.

The user may choose to save changes to the publicly displayed data settings of the user by entering a new value into the fields 2302-2316 and selecting a save selection 2318, or may cancel saving changes to the fields 2302-2316 by selecting a cancel selection 2230.

FIG. 24 illustrates an example user interface 2400 according to an example embodiment. In an example embodiment, the user preferences presented at block 416 (see FIG. 4) may include the user interface 2400. The user preferences may include format preference fields and selections 2402-2422, communication type fields and selections 2424-2442, and media posting selections 2444-2454.

The user may specify the receipt of targeted messages in one or more communication formats by use of the format preference fields and selections 2402-2422. The preference fields 2402, 2410, 2414, 2420 may indicate that the user seeks to receive the communications from the source server 106, 206 by a mobile device, a message center, e-mail, and a RSS feed respectively. The preference fields 2404, 2412, 2416, 2422 may indicate that the user does not seek to receive the communications from the source server 106, 206 by the mobile device, the message center, e-mail, and the RSS feed respectively. The user may identify the device used to receive the messages with a device selection field 2406 and a delivery format selection (e.g., text-only or HTML) of the communications with a delivery format selection field 2408. Other formats for sending communications (e.g., via facsimile) may also be used.

The user may specify the types of communications (e.g., targeted messages) that may be received by use of the communication type fields and selections 2424-2442. The preference fields 2424, 2430, 2434, 2440 may indicate that the user seeks to receive communications from the source server 106, 206 based on geographic region, favorites, user specified, and system generated respectively. The preference fields 2426, 2432, 2436, 2442 may indicate that the user does not seek to receive communications from the source server 106, 206 based on geographic region, favorites, user specified, and system generated respectively. Geographic areas (e.g., St. Louis, Mo.) in which the user seeks to receive communications may be specified in a geographic areas selection 2428. Favorites may be designated by a user by flagging system elements. One or more user selections of which the user may wish to receive communications may be specified in a user selection 2438. For example, the user selections may be particular performers, performer groups, venues, and the like.

In an example embodiment, the system generated communication types may be based on the users activity (e.g., events attended and interest in performer groups) within the source server 106, 206.

The media posting selections 2444-2454 may specify the data structures of which posted content by the user may be associated. The media posting selections 2444-2454 may respectively be for a user, an event, a performer, a performer group, a venue, and others.

The user may choose to save the preference changes by modifying the fields and selections 2402-2454 and selecting a save selection 2456, or may cancel saving changes to the fields and selections 2402-2454 by selecting a cancel selection 2458.

FIG. 25 illustrates an example user interface 2500 according to an example embodiment. In an example embodiment, the user data structure 1200 for a user as presented to the user of the source server 106, 206 (see FIGS. 1 and 2) may include the user interface 2500.

FIG. 26 illustrates an example user interface 2600 according to an example embodiment. The performer group data structure 1500 presented to a user of the source server 106, 206 (see FIGS. 1 and 2) may include the user interface 2600.

FIG. 27 illustrates an example user interface 2600 according to an example embodiment. The venue data structure 1300 presented to a user of the source server 106, 206 (see FIGS. 1 and 2) may include the user interface 2700.

FIG. 28 illustrates an example user interface 2800 according to an example embodiment. The event data structure 1700 presented to a user of the source server 106, 206 (see FIGS. 1 and 2) may include the user interface 2800.

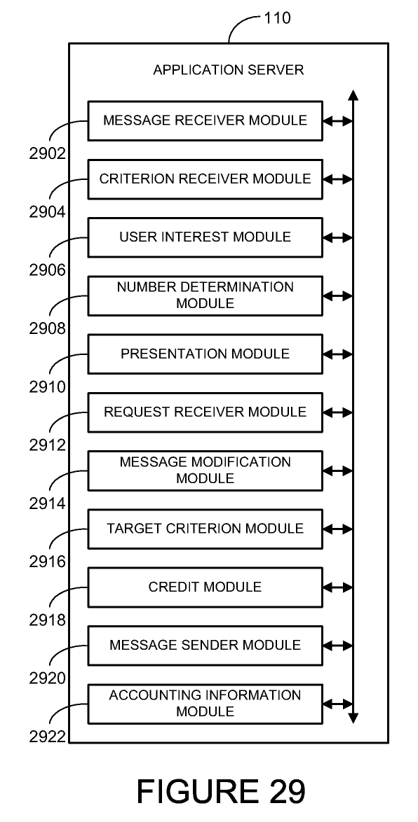

FIG. 29 illustrates an example application server 110 that may be deployed in the communication system 100, the communication system 200, and/or system.

The application server 110 may include a message receiver module 2902, a criterion receiver module 2904, a user interest module 2906, a number determination module 2908, a presentation module 2910, a request receiver module 2912, a message modification module 2914, a target criterion module 2916, a credit module 2918, a message sender module 2920, and/or an accounting information module 2922. Other modules may also be used.

The message receiver module 2902 receives a message from an originating user. The criterion receiver module 2904 receives a target criterion from the originating user.

The user interest module 2906 determines a user interest of users of an event messaging application based on interaction between the users and the event messaging application and/or receives a user interest from the target users, the user interest being included with the target criterion.

The number determination module 2908 determines a number of a target users meeting the target criterion, the target users associated with a server, the meeting of the target criterion based on target user data associated with the server.

The presentation module 2910 presents the number of the target users associated with the target criterion to the originating user, a cost associated with sending the message to the number of the target users associated with the target criterion, and//or the message to the originating user.

The request receiver module 2912 receives a delivery request, a message modification request, and/or target criterion modification request from the originating user.

The message modification module 2914 modifies the message in accordance with the message modification request to create a modified message. The target criterion module 2916 modifies the target criterion in accordance with the target criterion modification request to create a modified target criterion.

The credit module 2918 determines whether the originating user has sufficient credit to send the message to the target users, sends an additional credit request to the originating user; and/or processes additional credit received from the originating user in response to the additional credit request.

The message sender module 2920 sends the message or the modified message to the target users or a revised number of the revised targets based on the receiving of the delivery request. The accounting information module 2922 updates accounting information associated with the originating user.

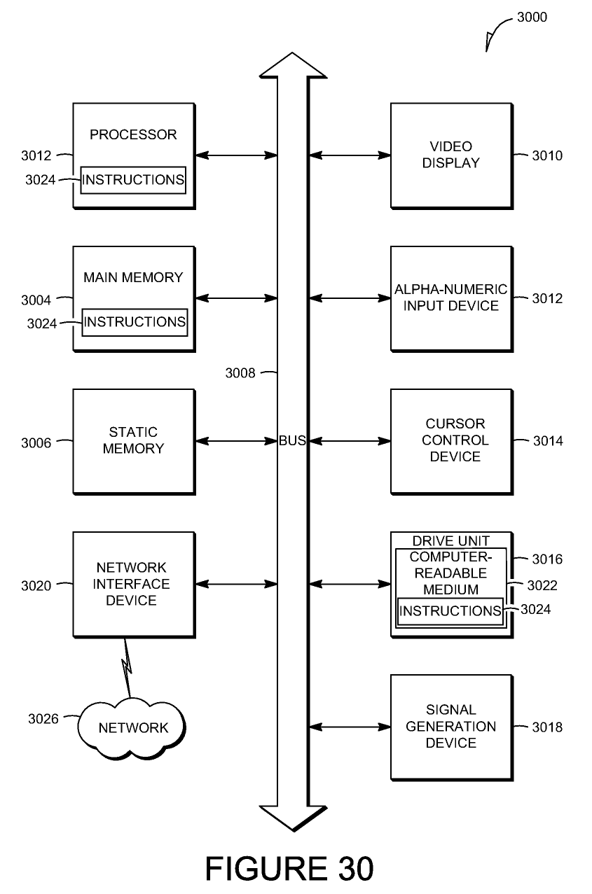

FIG. 30 shows a diagrammatic representation of machine in the example form of a computer system 3000 within which a set of instructions may be executed causing the machine to perform any one or more of the methods, processes, operations, or methodologies discussed herein. The source server 106 may be deployed on the computer system 3000. The communication device 102, the interface device 116, and/or the provider device 222 may include the functionality of the computer system 3000.

In an example embodiment, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 3000 includes a processor 3002 (e.g., a central processing unit (CPU) a graphics processing unit (GPU) or both), a main memory 3004 and a static memory 3006, which communicate with each other via a bus 3008. The computer system 3000 may further include a video display unit 3010 (e.g., a liquid crystal display (LCD) or a cathode ray tube (CRT)). The computer system 3000 also includes an alphanumeric input device 3012 (e.g., a keyboard), a cursor control device 3014 (e.g., a mouse), a drive unit 3016, a signal generation device 3018 (e.g., a speaker) and a network interface device 3020.

The drive unit 3016 includes a machine-readable medium 3022 on which is stored one or more sets of instructions (e.g., software 3024) embodying any one or more of the methodologies or functions described herein. The software 3024 may also reside, completely or at least partially, within the main memory 3004 and/or within the processor 3002 during execution thereof by the computer system 3000, the main memory 3004 and the processor 3002 also constituting machine-readable media.

The software 3024 may further be transmitted or received over a network 3026 via the network interface device 3020.

While the machine-readable medium 3022 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies shown in the various embodiments of the present invention. The term “machine-readable medium” shall accordingly be taken to include, but not be limited to, solid-state memories, optical and magnetic media, and carrier wave signals.

Certain systems, apparatus, applications or processes are described herein as including a number of modules or mechanisms. A module or a mechanism may be a unit of distinct functionality that can provide information to, and receive information from, other modules. Accordingly, the described modules may be regarded as being communicatively coupled. Modules may also initiate communication with input or output devices, and can operate on a resource (e.g., a collection of information). The modules be implemented as hardware circuitry, optical components, single or multi-processor circuits, memory circuits, software program modules and objects, firmware, and combinations thereof, as appropriate for particular implementations of various embodiments.

Thus, methods and systems for targeted communication have been described. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method comprising:
receiving a message from an originating user;
receiving a target criterion from the originating user;
determining a number of a plurality of target users meeting the target criterion, the plurality of target users being associated with a server, the meeting of the target criterion being based on target user data associated with the server;
presenting, to the originating user, the number of the plurality of target users associated with the target criterion;
receiving a delivery request from the originating user; and
sending the message to the plurality of target users based on the receiving of the delivery request.

2. The method of claim 1, further comprising:
receiving a message modification request; and
modifying the message in accordance with the message modification request to create a modified message;
wherein the modified message is sent to the plurality of target users.

3. The method of claim 1, further comprising:
receiving a target criterion modification request;
modifying the target criterion in accordance with the target criterion modification request to create a modified target criterion;
determining a revised number of the plurality of revised target users meeting the modified target criterion; and
presenting, to the originating user, the revised number of the plurality of revised target users associated with the modified target criterion;
wherein the message is sent to the plurality of revised target users.

4. The method of claim 1, wherein the presenting further comprises:
presenting, to the originating user, a cost associated with sending the message to the number of the plurality of target users associated with the target criterion.

5. The method of claim 1, further comprising:
determining whether the originating user has sufficient credit to send the message to the plurality of target users; and
wherein the sending of the message to the plurality of target users includes basing the message to the target users on the receiving of the delivery request and the determining of the sufficient credit.

6. The method of claim 5, further comprising:
sending an additional credit request to the originating user; and
processing additional credit received from the originating user in response to the additional credit request;
wherein the processing of the additional credit enables the originating user to have the sufficient credit to send the message.

7. The method of claim 1, wherein the presenting comprises:
presenting the number of the plurality of target users to receive the message in a plurality of geographic areas.

8. The method of claim 1, wherein the presenting further comprises:
presenting the message to the originating user.

9. The method of claim 1, further comprising:
updating accounting information associated with the originating user.

10. The method of claim 1, wherein the message includes a non-source identifier, the non-source identifier capable of being used to associate one or responses received with the message.

11. The method of claim 1, wherein an event messaging application is operating on the server, the event messaging application being capable of sending the message.

12. The method of claim 1, wherein the target criterion includes at least one of an age range, a geographic location, a user interest, or combinations thereof.

13. The method of claim 1, further comprising:
determining a user interest of a plurality of users of an event messaging application based on interaction between the plurality of users and the event messaging application, the plurality of target users being among the plurality of users, the user interest being included with the target criterion.

14. The method of claim 1, further comprising:
receiving a user interest from the plurality of target users, the user interest being included with the target criterion.

15. The method of claim 1, wherein the message is sent to a mobile device associated with each of the plurality of target users.

16. A system comprising:
a message receiver module to receiving a message from an originating user;
a criterion receiver module to receive a target criterion from the originating user;
a number determination module to determine a number of a plurality of target users meeting the target criterion, the plurality of target users being associated with a server, the meeting of the target criterion being based on target user data associated with the server;
a presentation module to present, to the originating user, the number of the plurality of target users associated with the target criterion;
a request receiver module to receive a delivery request from the originating user; and
a message sender module to send the message to the plurality of target users based on the receiving of the delivery request.

17. The system of claim 16, further comprising:
a credit module to determine whether the originating user has sufficient credit to send the message to the plurality of target users.

18. The system of claim 16, wherein the message includes a system code.

19. A machine-readable medium comprising instructions, which when implemented by one or more processors perform the following operations:
receive a message from an originating user;
receive a target criterion from the originating user;
determine a number of a plurality of target users meeting the target criterion, the plurality of target users being associated with a server, the meeting of the target criterion being based on target user data associated with the server;
present, to the originating user, the number of the plurality of target users associated with the target criterion;
receive a delivery request from the originating user; and
send the message to the plurality of target users based on the receiving of the delivery request.

20. The machine-readable medium of claim 19, wherein the one or more instructions to present the number further includes:
present, to the originating user, a cost associated with sending the message to the number of the plurality of target users associated with the target criterion.
